(19) United States
(12) Patent Application Publication
(10) Pub. No.: US 2010/0061220 A1
(43) Pub. Date: Mar. 11, 2010

(54) OPTICAL DATA RECORDING AND IMAGING ON MEDIA USING APOCHROMATIC LENSES

(76) Inventors: Makarand P. Gore, Fort Collins, CO (US); Anurag Gupta, Tucson, AZ (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/447,906

(22) PCT Filed: Nov. 9, 2007
(86) PCT No.: PCT/US2007/084324

§ 371 Date: Apr. 30, 2009

Related U.S. Application Data
(60) Provisional application No. 60/857,910, filed on Nov. 10, 2006.

(51) Int. Cl. G11B 3/70

(52) U.S. Cl. 369/272.1; G9B/3.103

(57) ABSTRACT

An apparatus for recording and/or transmitting optical data or visual images includes a recording medium (100) having a substrate (220) and markable coating (230). The apparatus also includes a recording and transmitting device including a light source (150) having at least two separate lasers, and a unified apochromatic lens structure (148) having at least two separate lenses functioning as one structure. The lens structure (148) enables light beams (152) to a) pass therethrough onto the medium (100) with at least two different wavelengths directed to a single spot, so as to cause a localized change in chemical and/or physical properties to form an optically detectable mark (242) in the markable coating (230) and/or b) pass therethrough onto the medium (100) with at least two different wavelengths directed to a single spot, so as to cause an optically detectable mark (242) to reflect the light beams (152). The light beams (152) have radiation different from a wavelength suitable for forming the optically detectable mark (242).

### CROSS-REFERENCE TO RELATED APPLICATIONS

The present application claims the benefit of U.S. Provisional Patent Application Ser. No. 60/857,910, filed Nov. 10, 2006, the contents of which are hereby incorporated by reference.

### BACKGROUND

The present disclosure relates generally to apparatuses, methods and materials that produce color change upon stimulation with radiation and are used in optical recording media, imaging media and devices. Further, widespread adoption of and rapid advances in technologies relating to optical recording and imaging media have created a desire for greatly increased data storage capacity in such media. Thus, optical storage technology has evolved from the compact disc (CD) and laser disc (LD) to far denser data types such as digital versatile disc (DVD) and blue laser formats such as BLU-RAY and high-density DVD (HD-DVD). “BLU-RAY” and the BLU-RAY Disc logo mark are trademarks of the BLU-RAY Disc Founders, which consists of 13 companies in Japan, Korea, Europe, and the U.S.

In each case, the optical data or visual image recording medium includes a substrate, typically a disc, on which is deposited a layer on which a mark can be created. In some media, the mark is a “pit,” or indentation in the surface of the layer, and the spaces between such pits are called “lands.” In other media, the mark is a localized region in which the optical properties, such as reflectivity or transparency, are modified. A marked disc can be read by directing a laser beam at the marked surface and recording changes in the reflected beam as the beam moves across the surface of the medium. An optical recording medium generally consists of any surface coated with a material that can be read using an incident light beam.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a semi-schematic perspective view and block diagram illustrating an embodiment of an optical disc recording system;

FIG. 2 is a schematic side elevation view of an embodiment of a recordable optical disc shown in conjunction with a partial block diagram of some of the elements of the system represented in FIG. 1; and

FIG. 3 is a semi-schematic side view of an apochromatic triplet lens.

### NOTATION AND NOMENCLATURE

Certain terms are used throughout the following description and claims to refer to particular system components. As one skilled in the art will appreciate, a component may be referred to by different names. This document does not intend to distinguish between components that differ in name but not function.

In the following discussion and in the claims, the terms “including” and “comprising” are used in an open-ended fashion, and thus should be interpreted to mean “comprising, but not limited to . . . ”

Reference is made herein to BLU-RAY technologies. Disc specifications for BLU-RAY discs currently include the following: wavelength=405 nm; numerical aperture (NA)=0.85; disc diameter=12 cm; disc thickness=1.2 mm; and data capacity23.3/25/27 GB. BLU-RAY discs can currently be used to store 2 hours of high resolution video images or 13 hours of conventional video images. A blue-violet laser having a wavelength ranging between 380 nm and 420 nm, and particularly 405 nm, is used as the light source for BLU-RAY discs. Another example of storage media and technology using blue light (380˜420 nm radiation) is HD-DVD. Furthermore, “Hybrid” media, methods and devices capable of writing and reading at 405 nm, 650 nm and 780 nm +/−30 nm are in development.

As used herein, the term “leuco dye” refers to a color-forming substance that is colorless or one color in a non-activated state, and that produces or changes color in an activated state. As used herein, the terms “developer” and “develop” describe a substance that reacts with the dye and causes the dye to alter its chemical structure and change or acquire color.

The term “light” as used herein includes electromagnetic radiation of any wavelength or band and from any source, such as a LASER diode or LED.

### DETAILED DESCRIPTION

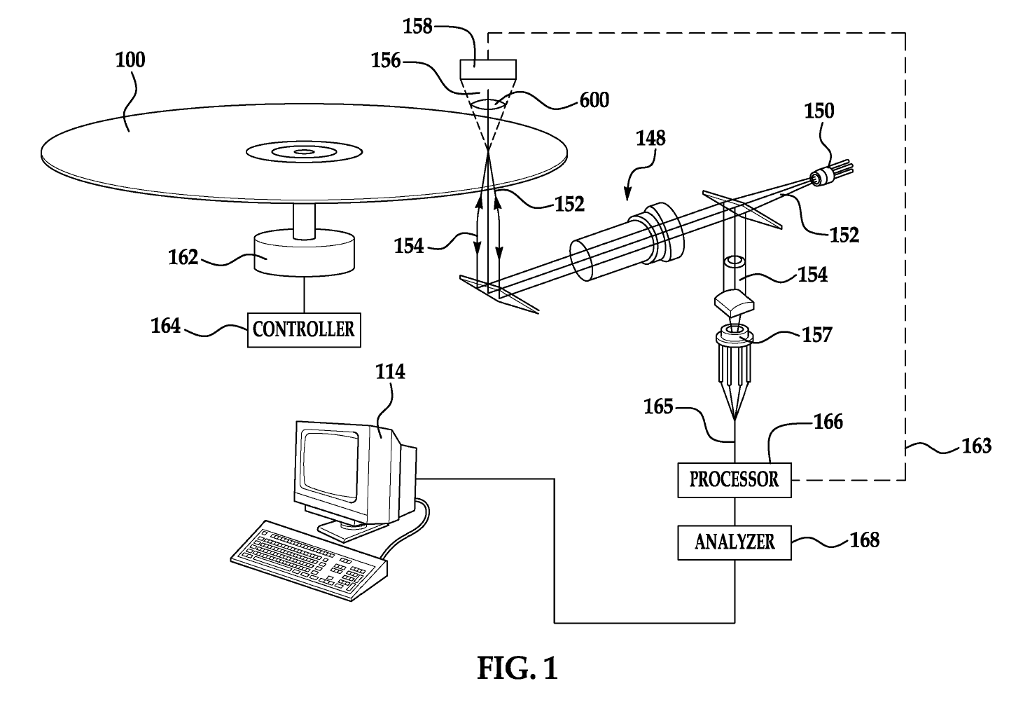

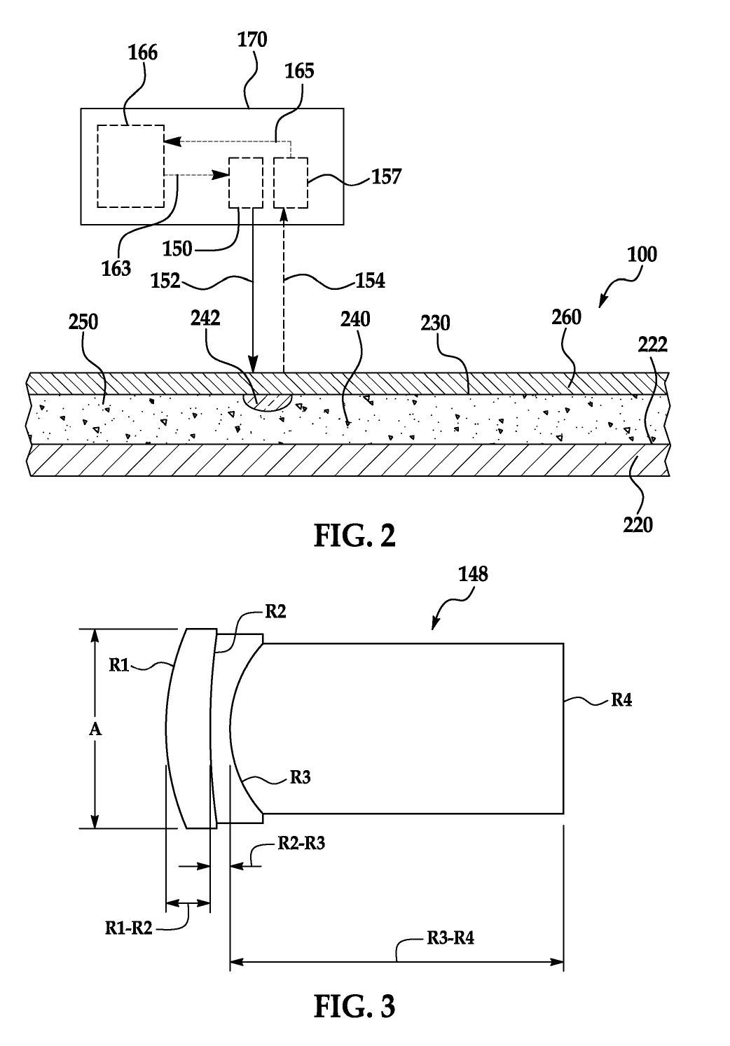

Referring to FIG. 1, there is shown a semi-schematic representation in perspective and block diagram illustrating optical components (e.g., an apochromatic triplet lens with three ray traces passing through it) 148, a light source 150 that produces the incident energy beam 152, a return beam 154 which is detected by the pickup 157, and a transmitted beam 156. In the transmissive optical disc form, the transmitted beam 156 is detected by a top detector 158 via lens or optical system 600, and is also analyzed for the presence of signal agents. In the transmissive embodiment, a photo detector may be used as a top detector 158. It is to be understood that FIG. 2 shows an abbreviated block diagram of the read/write system 170 illustrating some of the same optical components shown in FIG. 1.

FIG. 1 also illustrates a drive motor 162 and a controller 164 for controlling the rotation of the optical disc/imaging medium 100. FIG. 1 further shows a processor 166 and analyzer 168 implemented in the alternative for processing the return beam 154 with a signal 165 from the pickup 157 to the processor 166, as well as processing a transmitted beam 156 from a signal 163 transmitted from the optical detector 158 and associated with the transmissive optical disc format. A display monitor 114 is also provided for displaying the results of the processing.

Referring briefly to FIG. 2, there is shown (in a schematic partial block diagram) the read/write system 170 that applies an incident energy beam 152 onto the imaging medium 100. Imaging medium 100 includes a substrate 220 and a marking layer 230 on a surface 222 thereof. In the embodiment shown, imaging medium 100 further includes a protective layer 260.

As described in detail below, marking layer 230 preferably includes a color-forming agent 240 dissolved in a matrix or binder 250. Marking layer 230 may include a polymeric matrix and may include an optional fixing agent and/or a radiation absorber (not shown). Substrate 220 may be any substrate upon which it is desirable to make a mark, such as, by way of example, the polymeric substrate of a CD-R/RW/ROM, DVD±R/RW/ROM, HD-DVD or BLU-RAY disc. Substrate 220 may be paper (e.g., labels, tickets, receipts, or stationery), an overhead transparency, or another surface upon which it is desirable to provide marks. Marking layer 230 may be applied to substrate 220 via any acceptable method, such as, for example, rolling, spin-coating, spraying, lithography, screen printing, or the like.

When it is desired to make a mark, incident energy beam 152 is directed in a desired manner at imaging medium 100. The form of the energy may vary, depending, at least in part, upon the equipment available, ambient conditions, and desired result. Examples of energy (also referred to herein as radiation) that may be used include, but are not limited to, infra-red (IR) radiation, ultra-violet (UV) radiation, x-rays, or visible light. In these embodiments, imaging medium 100 is illuminated with light having the predetermined wavelength at the location where it is desirable to form a mark.

An embodiment disclosed herein relates to a recording and transmitting device including a light source 150. The light source 150 includes at least two separate lasers (not shown) and a unified apochromatic lens structure (an embodiment of which is shown in FIG. 3) which includes at least two separate lenses functioning as one structure. In one embodiment, the lens structure includes at least three separate lenses incorporated as one structure. The lens structure enables the light beams from the light source 150 to pass through the lens structure onto the imaging medium 100 such that at least two different wavelengths are focused to a single spot on the imaging medium 100. The at least two different wavelengths cause a localized change in chemical and/or physical properties to form an optically detectable mark 242 in the markable coating/layer 230. The lens structure also enables the light beams to pass through the lens structure onto the imaging medium 100 with at least two different wavelengths focused to a single spot on the imaging medium 100. The light beams cause an optically detectable mark 242 to reflect light from the light source 150. In order to reflect light from the light source 150 without marking the imaging medium 100, it is to be understood that the light from the light source 150 has radiation different from (either above or below) a wavelength suitable for forming an optically detectable mark 242 in the markable coating 230.

The marking layer 230 absorbs the radiation at an absorption wavelength range selected from the group consisting of 370 nm to 380 nm, 380 nm to 420 nm, 400 nm to 415 nm, 468 nm to 478 nm, 650 nm to 660 nm, 780 nm to 787 nm, 970 nm to 990 nm, and 1520 nm to 1580 nm, thereby causing a change in marking layer 230 and producing an optically detectable mark 242.

In yet another embodiment, the marking layer 230 absorbs the radiation at three wavelengths: 405 nm, 650 nm, and 780 nm. The wavelengths together are focused to a single spot, the single spot having a diameter ranging from about 100 nanometers to about 10 microns.

The color-forming agent 240 may be any substance that undergoes a detectable optical change in response to a threshold stimulus, which may be applied in the form of light or heat. In some embodiments, the color-forming agent 240 includes a leuco dye and a developer, as described in detail below. The developer and the leuco dye produce a detectable optical change when chemically mixed. The concentration and distribution of the color-forming components 240 in marking layer 230 are sufficient to produce a detectable mark 242 when activated.

In many embodiments, it may be desirable to provide a marking layer 230 that is equal to or less than one micron (μm) thick. In order to achieve this, spin coating is one suitable application technique. In addition, it is desirable to provide a marking composition that is capable of forming a layer occupying the predetermined thickness (i.e., equal to or less than one micron (μm) thick). Thus, in such cases, the marking layer 230 should be, inter alia, free from particles that would prevent formation of such a layer, i.e., free from particles having a dimension greater than 1 μm. In some cases, the materials forming color or contrast are completely soluble in the coating solvent.

Furthermore, in many applications it may be desirable to provide a markable coating that is transparent. In such a case, any particles present in the coating would have an average size less than the wavelength of the light to which the coating is transparent. While a coating in which all particles are smaller than 1 μm would serve this purpose, it may be more desirable to utilize a coating in which the marking components are dissolved, as opposed to one in which they are present as particles. Still further, as target data densities increase, the dot size, or mark size, that can be used for data recording decreases. Some currently available technologies require an average dot size of 1 μm or less. For all of these reasons, marking layer 230 is therefore preferably, but not necessarily, entirely free of particles.

In a marking layer 230 in which both color-forming components 240 are dissolved, it may be necessary to prevent the color-forming components 240 from combining prematurely and generating an optical change across the entire marking layer. According to certain embodiments, this can be accomplished by providing a protective moiety on either the dye or the developer.

It is to be understood that the resulting mark 242 can be detected by an optical sensor, thereby producing an optically readable device.

Therefore, in another embodiment, the optical data or image recording and transmitting (i.e., reading) device includes additional parts used for optically transmitting data. It is to be understood that these other parts are in addition to the light source 150 with its at least two separate lasers and the unified apochromatic lens structure with its at least two separate lenses. One of the additional parts includes a sensor (e.g., optical pickup 157) positioned so as to detect at least one readable pattern of the optically detectable marks 242 on the imaging medium 100. Generally, the sensor reads at least one readable pattern as the imaging medium 100 moves in relation to the sensor. Another of the additional parts includes a processor 166. The processor 166 functions by receiving at least one signal (based on the at least one readable pattern detected by the sensor) sent by the sensor.

Depending on the color-forming agent 240 selected, the marking composition may become relatively more or relatively less absorbing at a desired wavelength upon activation. Because many commercial and consumer products use a single wavelength for both read and write operations, and because a color-forming agent 240 that produces a mark 242 that is relatively absorbing (relative to the unmarked regions) at the read wavelength is particularly advantageous, it is desirable to provide a color-forming agent 240 that produces a mark 242 that is relatively absorbing at the read/write wavelength.

In an embodiment of the apochromatic lens structure of the present disclosure, the structure has three component lenses, all of which are cemented together to form a triplet. To achieve apochromatic properties, three different glass types are used (examples of which are provided hereinbelow). It is to be understood that the structure need not be limited to three glass types, and that any other glass (e.g., quartz or the like) or plastic materials may be used. The lenses need not even be cemented together. Air-spaced lenses which are not cemented together can achieve the same effect, and in some instances, at less cost. The cementing of the lenses together achieves compactness. The lenses can also be molded and placed, for example, in a barrel-shaped container. The manufacturing process may be, for example, by injection molding.

FIG. 3 shows a non-limiting example of an embodiment of an apochromatic triplet lens 148 with dimensions that can be varied according to results desired to be achieved. All surfaces are shown as spherical, although it is to be understood that non-spherical surfaces could also be used. As non-limiting examples, the glass aperture (A) diameter is 5 mm, while the width of the triplet lens structure as the light travels horizontally across the lens is 10 mm. The horizontal length of the first lens R1-R2 is 1.12 mm, the horizontal length of the second lens R2-R3 is 0.5 mm, and the horizontal length of the third lens R3-R4 is 8.38 mm.

Traveling from left to right across the lens triplet structure 148, the same direction the light travels, the first surface R1 has a radius of curvature of 6.2 mm, the second surface R2 has a radius of curvature of 17.95 mm, the third surface R3 has a radius of curvature of 3.17 mm, and the fourth surface R4 has a radius of curvature of 39.74 mm.

The apochromatic lens 148 of this example is capable of focusing collimated light at 5 mm distance away from R4. Light enters from the R1 side. As a non-limiting example, the lens 148 focuses three wavelengths of 405 nm, 605 nm and 780 nm respectively on the same spot on the disc (e.g, imaging medium 100). In an embodiment, the root mean square (RMS) spot diameter on the disc is 2.1 μm on-axis, and the lens 148 has a full field of view of 2°.

In this example, the glass used for the first lens (R1-R2) is LASFN15, the glass used for the second lens (R2-R3) is KZFS12, and the glass used for the third lens (R3-R4) is PK51A. The glass alphanumeric designations are based on the well-known lens labeling terminology used in the catalog of Schott Glass Company.

The traditional Optical Processing Unit (OPU) is designed to use a single wavelength on a single spot to provide a very small mark on one location. The optical recording of data on a disc requires multiple spots to be focused at different locations for asynchronous or stepwise processing. Therefore, under such conditions, different optical requirements are placed on an Optical Print Head (OPH). One simple solution is to have different lenses, one for each wavelength and different optical paths for different locations. This may be costly however, since it involves multiple lenses, multiple focus control mechanisms and circuits, etc.

In the present disclosure, a different solution is obtained for focusing multiple wavelengths at different locations on, for example, an optical disk with a single optical package. With such a single optical package, the optical package having at least two lenses, it is possible to obtain a spot size diameter in the range of about 100 nanometers to about 10 microns. More specifically, a spot size diameter in the range from about 100 nanometers to about 1 micron may be desirable for data recording purposes. By the same token, a spot size ranging from about 1 micron to about 10 microns may be desirable for image recording purposes. Embodiments of the present disclosure can therefore serve both purposes. Wavelengths used to obtain such spot sizes in a non-limiting embodiment include, for example, 405 nm, 650 nm and 780 nm.

### Dyes

By way of example, if blue-violet light (radiation) is to be used as the read radiation, the marks 242 formed in the marking layer 230 are preferably a contrasting color, namely yellow to orange, indicating absorption of blue radiation. In certain embodiments, therefore, the marking composition contains a leuco dye that, when activated, changes from being relatively non-absorbing at blue-violet wavelengths to being relatively absorbing at those wavelengths.

Nonetheless, embodiments disclosed herein are not limited to such dyes. Specific examples of leuco dyes suitable for use herein include fluorans and phthalides, which include but are not limited to the following and which can be used alone or in combination: 1,2-benzo-6-(N-ethyl-N-toluidino)fluoran, 1,2-benzo-6-(N-methyl-N-cyclohexylamino)-fluoran, 1,2-benzo-6-dibutylaminofluoran, 1,2-benzo-6-diethylaminofluran, 2-(α-phenylethylamino)-6-(N-ethyl-p-toluidino)fluoran, 2-(2,3-dichloroanilino)-3-chloro-6-diethylaminofluran, 2-(2,4-dimethylanilino)-3-methyl-6-diethylaminofluoran, 2-(di-p-methylbenzilamino)-6-(N-ethyl-p-toluidino)fluoran, 2-(m-trichloromethylanilino)-3-methyl-6-(N-cyclohexyl-N-methylamino)fluoran, 2-(m-trichloromethylanilino)-3-methyl-6-diethylanimofluoran, 2-(m-trifluoromethylaniline)-6-diethylaminofluoran, 2-(m-trifluoromethylanilino)-3-chloro-6-diethylaminofluran, 2-(m-trifluoromethylanilino)-3-methyl-6-diethylanimofluoran, 2-(N-ethyl-p-toluidino)-3-methyl-6-(N-ethylanilino)fluoran, 2-(N-ethyl-p-toluidino)-3-methyl-6-(N-propyl-p-toluidino) fluoran, 2-(o-chloroanilino)-3-chloro-6-diethlaminofluoran, 2-(o-chloroanilino)-6-dibutylaminofluoran, 2-(o-chloroanilino)-6-diethylaminofluoran, 2-(p-acetylanilino)-6-(N-n-amyl-N-n-butylamino)fluoran, 2,3-dimethyl-6-dimethylaminofluoran, 2-amino-6-(N-ethyl-2,4-dimethylanilino)fluoran, 2-amino-6-(N-ethylanilino)fluoran, 2-amino-6-(N-ethyl-p-chloroanilino)fluoran, 2-amino-6-(N-ethyl-p-ethylanilino)fluoran, 2-amino-6-(N-ethyl-p-toluidino)fluoran, 2-amino-6-(N-methyl-2,4-dimethylanilino)fluoran, 2-amino-6-(N-methylanilino)fluoran, 2-amino-6-(N-methyl-p-chloroanilino)fluoran, 2-amino-6-(N-methyl-p-ethylanilino)fluoran, 2-amino-6-(N-methyl-p-toluidino)fluoran, 1-amino-6-(N-propyl-2,4-dimethylanilino)fluoran, 2-amino-6-(N-propylanilino)fluoran, 2-amino-6-(N-propyl-p-chloroanilino)fluoran, 2-amino-6-(N-propyl-p-ethylanilino)fluoran, 2-amino-6-(N-propyl-p-toluidino)fluoran, 2-anilino-3-chloro-6-diethylaminofluran, 2-anilino-3-methyl-6-(N-cyclohexyl-N-methylamino)fluoran, 2-anilino-3-methyl-6-(N-ethyl-N-isoamylamino)fluoran, 2-anilino-3-methyl-6-(N-ethyl-N-p-benzyl)aminofluoran, 2-anilino-3-methyl-6-(N-ethyl-N-propylamino)fluoran, 2-anilino-3-methyl-6-(N-iso-amyl-N-ethylamino)fluoran, 2-anilino-3-methyl-6-(N-isobutyl-methyl amino)fluoran, 2-anilino-3-methyl-6-(N-isopropyl-methyl amino)fluoran, 2-anilino-3-methyl-6-(N-methyl-p-toluidino-)fluoran, 2-anilino-3-methyl-6-(N-n-amyl-N-ethylamino)fluoran, 2-anilino-3-methyl-6-(N-n-amyl-N-methylamino)fluoran, 2-anilino-3-methyl-6-(N-n-propyl-N-isopropylamino)fluoran, 2-anilino-3-methyl-6-(N-n-propyl-N-methylamino)fluoran, 2-anilino-3-methyl-6-(N-sec-butyl-N-methylamino)fluoran, 2-anilino-3-methyl-6-diethylaminofluoran, 2-anilino-3-methyl-6-di-n-butylaminofluoran, 2-anilino-6-(N-n-hexyl-N-ethylamino)fluoran, 2-benzilamino-6-(N-ethyl-2,4-dimethylanilino)fluoran, 2-benzilamino-6-(N-ethyl-p-toluidino)fluoran, 2-benzilamino-6-(N-methyl-2,4-dimethylanilino)fluoran, 2-benzilamino-6-(N-methyl-p-toluidino)fluoran, 2-bromo-6-diethylaminofluoran, 2-chloro-3-methyl-6-diethylaminofluran, 2-chloro-6-(N-ethyl-N-isoamylamino)fluoran, 2-chloro-6-diethylaminofluoran, 2-chloro-6-dipropylaminofluoran, 2-diethylamino-6-(N-ethyl-p-toluidino)fluoran, 2-diethylamino-6-(N-methyl-p-toluidino)fluoran, 2-dimethylamino-6-(N-ethylanilino)fluoran, 2-dimethylamino-6-(N-methylanilino)fluoran, 2-dipropylamino-6-(N-ethylanilino)fluoran, 2-dipropylamino-6-(N-methylanilino)fluoran, 2-ethylamino-6-(N-ethyl-2,4-dimethylanilino)fluoran, 2-ethylamino-6-(N-methyl-p-toluidino)fluoran, 2-methylamino-6-(N-ethylanilino)fluoran, 2-methylamino-6-(N-methyl-2,4-dimethylanilino)fluoran, 2-methylamino-6-(N-methylanilino)fluoran, 2-methylamino-6-(N-propylanilino)fluoran, 3-(1-ethyl-2-methylindole-3-yl)-3-(2-ethoxy-4-diethylaminophenyI)-4-azaphthalide, 3-(1-ethyl-2-methylindole-3-yl)-3-(2-ethoxy-4-diethylaminophenyl)-7-azaphthalide, 3-(1-ethyl-2-methylindole-3-yl)-3-(2-methyl-4-diethylaminophenyl)-4-azaphthalide, 3-(1-ethyl-2-methylindole-3-yl)-3-(2-methyl-4-diethylaminophenyl)-7-azaphthalide, 3-(1-ethyl-2-methylindole-3-yl)-3-(4-diethylaminophenyl)-4-azaphthalide, 3-(1-ethyl-2-methylindole-3-yl)-3-(4-N-n-amyl-N-methylaminophenyl)-4-azaphthalide, 3-(1-methyl-2-methylindole-3-yl)-3-(2-hexyloxy-4-diethylaminophenyl)-4-azaphthalide, 3-(1-ethyl-2-methylindole-3-yl)-3-(2-ethoxy-4-diethylaminophenyl)-4-azaphthalide, 3-(N-cyclohexyl-N-methylamino)-6-methyl-7-phenylaminofluoran, 3-(N-ethyl-N-isoamylamino)-6-methyl-7-phenylaminofluoran, 3-(N-ethyl-p-toluidino)-6-methyl-7-phenylaminofluoran, 3,3-bis(2-ethoxy-4-diethylaminphenyl)-4-azaphthalide, 3,3-bis(2-ethoxy-4-diethylaminphenyl)-7-azaphthalide, 3,6-dibutoxyfluoran, 3,6-diethoxyfluoran, 3,6-dimethoxyfluoran, 3-bromo-6-cyclohexylaminofluoran, 3-chloro-6-cyclohexylaminofluoran, 3-dibutylamino-7-(o-chloro-phenylamino)fluoran, 3-diethylamino-5-methyl-7-dibenzylaminofluoran, 3-diethylamino-6-(m-trifluoromethylanilino)fluoran, 3-diethylamino-6,7-dimethylfluoran, 3-diethylamino-6-methyl-7-xylidinofluoran, 3-diethylamino-7-(2-carbomethoxy-phenylamino)fluoran, 3-diethylamino-7-(N-acetyl-N-methylamino)fluoran, 3-diethylamino-7-(N-chloroethyl-N-methylamino)fluoran, 3-diethylamino-7-(N-methyl-N-benzylamino)fluoran, 3-diethylamino-7-(o-chlorophenylamino)fluoran, 3-diethylamino-7-chlorofluoran, 3-diethylamino-7-dibenzylaminofluoran, 3-diethylamino-7-diethylaminofluoran, 3-diethylamino-7-N-methylaminofluoran, 3-dimethylamino-6-methoxylfluoran, 3-dimethylamino-7-methoxyfluoran, 3-methyl-6-(N-ethyl-p-toluidino)fluoran, 3-piperidino-6-methyl-7-phenylaminofluoran, 3-pyrrolidino-6-methyl-7-p-butylphenylaminofluoran, and 3-pyrrolidino-6-methyl-7-phenylaminofluoran.

Additional dyes that may be alloyed in accordance with embodiments disclosed herein include, but are not limited to leuco dyes, such as fluoran leuco dyes and phthalide color formers as are described in “The Chemistry and Applications of Leuco Dyes,” Muthyala, Ramiah, ed., Plenum Press (1997) (ISBN 0-306-45459-9). Embodiments may include almost any known leuco dye, including, but not limited to, amino-triarylmethanes, aminoxanthenes, aminothioxanthenes, amino-9,10-dihydro-acridines, aminophenoxazines, aminophenothiazines, aminodihydro-phenazines, aminodiphenylmethanes, aminohydrocinnamic acids (cyanoethanes, leuco methines) and corresponding esters, 2-(p-hydroxyphenyl)-4,5-diphenylimidazoles, indanones, leuco indamines, hydrozines, leuco indigoid dyes, amino-2,3-dihydroanthraquinones, tetrahalo-p, p′-biphenols, 2-(p-hydroxyphenyl)-4,5-diphenylimidazoles, phenethylanilines, and mixtures thereof.

Particularly suitable leuco dyes include: Specialty Yellow 37 (Noveon), NC Yellow 3 (Hodogaya), Specialty Orange 14 (Noveon), Perga Script Black IR (CIBA), and Perga Script Orange IG (CIBA).

Additional examples of suitable dyes include, but are not limited to: Pink DCF CAS#29199-09-5; Orange-DCF, CAS#21934-68-9; Red-DCF CAS#26628-47-7; Vermilion-DCF, CAS#117342-26-4; Bis(dimethyl)aminobenzoyl phenothiazine, CAS# 1249-97-4; Green-DCF, CAS#34372-72-0; chloroanilino dibutylaminofluoran, CAS#82137-81-3; NC-Yellow-3 CAS#36886-76-7; Copikem37, CAS#144190-25-0; Copikem3, CAS#22091-92-5, available from Hodogaya, Japan or Noveon, Cincinnati, USA.

Additional non-limiting examples of suitable fluoran-based leuco dyes include: 3-diethylamino-6-methyl-7-anilinofluoran, 3-(N-ethyl-p-toluidino)-6-methyl-7-anilinofluoran, 3-(N-ethyl-N-isoamylamino)-6-methyl-7-anilinofluoran, 3-diethylamino-6-methyl-7-(o,p-dimethylanilino)fluoran, 3-pyrrolidino-6-methyl-7-anilinofluoran, 3-piperidino-6-methyl-7-anilinofluoran, 3-(N-cyclohexyl-N-methylamino)-6-methyl-7-anilinofluoran, 3-diethylamino-7-(m-trifluoromethylanilino) fluoran, 3-dibutylamino-6-methyl-7-anilinofluoran, 3-diethylamino-6-chloro-7-anilinofluoran, 3-dibutylamino-7-(o-chloroanilino)fluoran, 3-diethylamino-7-(o-chloroanilino)fluoran, 3-di-n-pentylamino-6-methyl-7-anilinofluoran, 3-di-n-butylamino-6-methyl-7-anilinofluoran, 3-(n-ethyl-n-isopentylamino)-6-methyl-7-anilinofluoran, 3-pyrrolidino-6-methyl-7-anilinofluoran, 1(3H)-isobenzofluranone, i-bis [2-[4-(dimethylamino)phenyl]-2-(4-methoxyphenyl)ethenyl]4,5,6,7-tetrachloro phthalide, and mixtures thereof. Aminotriarylmethane leuco dyes may also be used in embodiments disclosed herein, such as tris(N,N-dimethylaminophenyl) methane (LCV); tris(N,N-diethylaminophenyl) methane (LECV); tris(N,N-di-n-propylaminophenyl) methane (LPCV); tris(N,N-di-n-butylaminophenyl) methane (LBCV); bis(4-diethylaminophenyl)-(4-diethylamino-2-methyl-phenyl) methane (LV-1); bis(4-diethylamino-2-methylphenyl)-(4-diethylamino-phenyl) methane (LV-2);

tris(4-diethylamino-2-methylphenyl) methane (LV-3); bis(4-diethylamino-2-methylphenyl) (3,4-diemethoxyphenyl) methane (LB-8); aminotriarylmethane leuco dyes having different alkyl substituents bonded to the amino moieties wherein each alkyl group is independently selected from C₁-C₄ alkyl; and aminotriarylmethane leuco dyes with any of the preceding named structures that are further substituted with one or more alkyl groups on the aryl rings wherein the latter alkyl groups are independently selected from C₁-C₃ alkyl.

### Developers

Examples of materials that may be used as developers include, without limitation, phenols, carboxylic acids, cyclic sulfonamides, protonic acids, compounds having a pKa of less than about 7.0, and mixtures thereof. Specific phenolic and carboxylic developers include, without limitation, boric acid, oxalic acid, maleic acid, tartaric acid, citric acid, succinic acid, benzoic acid, stearic acid, gallic acid, salicylic acid, 1-hydroxy-2-naphthoic acid, o-hydroxybenzoic acid, m-hydroxybenzoic acid, 2-hydroxy-p-toluic acid, 3,5-xylenol, thymol, p-t-butylphenyl, 4-hydroxyphenoxide, methyl-4-hydroxybenzoate, 4-hydroxyacetophenone, α-naphthol, naphthols, catechol, resorcin, hydroquinone, 4-t-octylcatechol, 4,4′-butylidenephenol, 2,2′-dihydroxydiphenyl, 2,2′-methylenebis(4-methyl-6-t-butylphenol), 2,2′-bis(4′-hydroxyphenyl)propane, 4,4′-isopropylidenebis(2-t-butylphenol), 4,4′-secbutylidenediphenol, pyrogallol, phloroglucine, phlorogluocinocarboxylic acid, 4-phenylphenol, 2,2′-methylenebis(4-chlorophenyl), 4,4′-isopropylidenediphenol, 4,4′-isopropylidenebis(2-chlorophenol), 4,4′-isopropylidenebis(2-methylphenol), 4,4′- ethylenebis(2-methylphenol), 4,4′-thiobis(6-t-butyl-3-methylphenol), bisphenol A and its derivatives (such as 4,4′-isopropylidenediphenol(bisphenol A)), 4-4′-cyclohexylidenediphenol, p,p′-(1-methyl-n-hexylidene) diphenol, 1,7-di(4-hydroxyphenylthio)-3,5-di-oxaheptane), 4-hydroxybenzoic esters, 4-hydroxyphthalic diesters, phthalic monoesters, bis(hydroxyphenyl)sulfides, 4-hydroxyarylsulfones, 4-hydroxyphenylarylsulfonates, 1,3-di[2-(hydroxyphenyI)-2-propyl]benzenes, 1,3-dihydroxy-6(α,α-dimethylbenzyl)benzene, resorcinols, hydroxybenzoyloxybenzoic esters, bisphenolsulfones, bis-(3-allyl-4-hydroxyphenyl)sulfone (TG-SA), bisphenolsulfonic acids, 2,4-dihydroxy-benzophenones, novolac type phenolic resins, polyphenols, saccharin, 4-hydroxy-acetophenone, p-phenylphenol, benzyl-p-hydroxybenzoate(benzalparaben), 2,2-bis(p-hydroxyphenyl) propane, p-tert-butylphenol, 2,4-dihydroxy-benzophenone, hydroxy benzyl benzoates, and p-benzylphenol.

In one aspect, the developer is a phenolic compound. In a more detailed aspect, the developer is a bisphenol such as bis(4-hydroxy-3-allylphenyl) sulphone (TG-SA). In yet another aspect, the developer compound is a carboxylic acid selected from the group consisting of boric acid, oxalic acid, maleic acid, tartaric acid, citric acid, succinic acid, benzoic acid, stearic acid, gallic acid, salicylic acid, ascorbic acid, and mixtures thereof.

### Protective Noieties

In some embodiments, the functional groups of the developers are each protected by a protective moiety. In one aspect, the protective moiety provides a mechanism for protecting the acid functional group of the developer. If the functional group of the developer is a hydroxy group, suitable protecting groups include, for example, esters, sulfonates, ethers, phosphinates, carbonates, carbamates (i.e. esters of carbamic acid), and mixtures thereof. In one detailed aspect, the protective moiety is an acyl group.

A variety of ethers may be used as protective moieties such as silyl ethers, alkyl ethers, aromatic ethers, and mixtures thereof. Several non-limiting examples of suitable ethers include methyl ether, 2-methoxyethoxymethyl ether (MEM), cyclohexyl ether, o-nitrobenzyl ether, 9-anthryl ether, tetrahydrothiopyranyl, tetrahydrothiofuranyl, 2-(phenylselenyl)ethyl ether, benzyloxymethyl ethers, methoxyethoxymethyl ethers, 2-(trimethylsilyl)ethoxymethyl ether, methylthiomethyl ether, phenylthiomethyl ether, 2,2-dichloro-1,1-difluoroethyl ether, tetrahydropyranyl, phenacyl, phenylacetyl, propargyl, p-bromophenacyl, cyclopropylmethyl ether, allyl ether, isopropyl ether, t-butyl ether, benzyl ether, 2,6-dimethylbenzyl ether, 4-methoxybenzyl ether, o-nitrobenzyl ether, 2-bromoethyl ether, 2,6-dichlorobenzyl ether, 4-(dimethylaminocarbonyl)benzyl ether, 9-anthrymethyl ether, 4-picolyl ether, heptafluoro-p-tolyl ether, tetrafluoro-4-pyridyl ether, silyl ethers (e.g., trimethylsilyl, t-butyldimethylsilyl, t-butyldiphenylsilyl, butyidiphenylsilyl, tribenzylsilyl, triisopropylsilyl, isopropyldimethylsilyl, 2-trimethylsilyl, 2-(trimethylsilyl) ethoxymethyl (SEM) ether, and mixtures thereof.

Several non-limiting examples of esters suitable for use as protective moieties include formate ester, acetate ester, isobutyrate ester, levulinate ester, pivaloate ester, aryl pivaloate esters, aryl methanesulfonate esters, adamantoate ester, benzoate ester, 2,4,6-trimethylbenzoate (mesitoate) ester, 2-trimethyl silyl ester, 2-trimethylsilyl ethyl ester, t-butyl ester, p-nitrobenzyl ester, nitrobutyl ester, trichloroethyl ester, any alkyl branched or aryl substituted ester, 9-fluorenecarboxylate, xanthenecarboxylate, and mixtures thereof. In one aspect, the protective moiety can be any of formate, acetate, isobutyrate, levulinate, pivaloate, and mixtures thereof.

Several non-limiting examples of carbonates and carbamates suitable for use as protective moieties include 2,2,2-trichloroethyl carbonate, vinyl carbonate, benzyl carbonate, methyl carbonate, p-nitrophenyl carbonate, p-nitrobenzyl carbonate, S-benzyl thiocarbonate, N-phenylcarbamate, 1-adamantyl carbonate, t-butyl carbonate, 4-methylsulfinylbenzyl, 2,4-dimethylbenzyl, 2,4-dimethylpent-3-yl, aryl carbamates, methyl carbamate, benzyl carbamate, cyclic borates and carbonates, and mixtures thereof.

Several non-limiting examples of phosphinates suitable for use as protective moieties include dimethylphosphinyl, dimethylthiophosphinyl, dimethylphosphinothioyl, diphenylphosphothioyl, and mixtures thereof.

Several non-limiting examples of sulfonates suitable for use as protective moieties include methanesulfonate, toluenesulfonate, 2-formylbenzenesulfonate, and mixtures thereof.

Exemplary protective moieties for hydroxyl functional groups of developers include, for example, t-butyloxycarbonyl, allyloxycarbonyl, benzyloxycarbonyl, o-nitrobenzyloxycarbonyl, and trifluoroacetate.

### Deprotection Agents

In order to facilitate removal of the protective moiety from the protected developer, embodiments of marking layer 230 include a deprotection agent. This ingredient facilitates removal of the protective moiety from the developer, thereby allowing the color-forming reaction to occur. In some embodiments, transfer of the protective moiety is stimulated by the application of heat. In some embodiments, the deprotection agent provides a mechanism for removing the above-described protective moieties via a chemical reaction therewith. Although it is recognized that the chemistry of some protective moieties would not always require a separate deprotection agent, such deprotection agents are considered to improve the stability and development of the leuco dyes.

Deprotection agents suitable for use herein include, without limitation, amines such as α-hydroxy amines, α-amino alcohols, primary amines and secondary amines. In one aspect, the deprotection agent can be valoneol, prolinol, 2-hydroxy-1-amino-propanol, 2-amino-3-phenyl-1-propanol, (R)-(−)-2-phenyl glycinol, 2-amino-phenylethanol, 1-naphthylethyl amine, 1-aminonaphthalene, morpholin, and the like. In another aspect, suitable deprotection agents include amines such as those boiling above 95° C., or above 110° C., including but not limited to, 2-amino-3-phenyl-1-propanol, (R)-(−)-2-phenyl glycinol, 2-amino-phenylethanol, or others, such as 1-naphthyl ethyl amine, 1-aminonaphthalene, morpholin, and the like.

The deprotection agent may be present at any concentration that is sufficient to react with enough protective moieties to allow a detectable color change in the leuco dye at the intended level of heat input. It will be understood that the concentration of the deprotection agent can be tailored to affect the speed and degree of the reaction upon exposure to heat. However, as a general guideline, the deprotection agent to developer molar ratio may range from about 10:1 to about 1:4, and in certain embodiments may range from about 1:1 to about 1:2.

The color forming compositions disclosed herein may include from about 6% to about 45% by weight of protected developer. In another embodiment, the protected developer may be present in an amount ranging from about 20% to about 40% by weight. In still a further detailed aspect, the protected developer may be present in an amount ranging from about 25% to about 38% by weight.

As mentioned above, when the color-forming agent 240 includes a color former, such as a leuco dye, and a protected developer, the matrix may be provided as a homogeneous, single-phase solution at ambient conditions, in part because the use of a protective moiety on the developer prevents the color-forming reaction from occurring prior to activation. Nonetheless, in other embodiments, one or the other of the components may be substantially insoluble in the matrix at ambient conditions. By “substantially insoluble,” it is meant that the solubility of that component of the color-forming agent 240 in the matrix at ambient conditions is so low, that no or very little color change occurs due to reaction of the dye and the developer at ambient conditions. Thus, in some embodiments, the developer is dissolved in the matrix with the dye being present as small crystals suspended in the matrix at ambient conditions; while in other embodiments, the color-former is dissolved in the matrix and the developer is present as small crystals suspended in the matrix at ambient conditions. When a two-phase system is used, the particle size is generally ½λ (wavelength) of the radiation, a non-limiting example of which is less than 400 nm.

Laser light having blue, indigo, red and far-red wavelength ranges from about 380 nm to about 420 nm; or 630 nm to 680 nm; or 770 nm to 810 nm can be used to develop the present color-forming compositions. Therefore, color-forming compositions may be selected for use in devices that emit wavelengths within this range. For example, if the light source emits light having a wavelength of about 405 nm, the precursor can be selected to absorb and rearrange at or near that wavelength. In other embodiments, light sources of other wavelengths, including but not limited to 650 nm or 780 nm, may be used. In either case, a radiation absorber tuned to the selected wavelength may be included so as to enhance a localized change of chemical and/or physical properties. Radiation absorbers suitable for this purpose are known.

In some embodiments, for example, the light source 150 may operate within a range of wavelengths from about 770 nm to about 810 nm. In general, in addition to the ranges given above, any of the ranges of light source displayed in Table 1 can be used to develop contrast.

TABLE 1
Laser Sources

| | | | Emission, | Light | | | | |
|---|---|---|---|---|---|---|---|---|
| Wavelength | | | perpendicular | Output | | Voltage | Input | |
| min | Typ | max | Angle | (Emission) | Current | nominal | Power | Efficiency |
| nm | Nm | nm | Degrees | mW | mA | V | mW | % |
| 370 | 375 | 380 | 24 | 10 | 70 | 5 | 350 | 3% |
| 400 | 408 | 415 | 23 | 30 | 45 | 4.5 | 203 | 15% |
| 435 | 440 | 445 | 22 | 20 | 40 | 5 | 200 | 10% |
| 468 | 473 | 478 | 22 | 5 | 40 | 5 | 200 | 3% |
| 650 | 656 | 660 | 22 | 50 | 80 | 2.6 | 208 | 24% |
| 780 | 784 | 787 | 16 | 100 | 141 | 2.1 | 296 | 34% |
| 970 | 980 | 990 | 18 | 200 | 270 | 1.76 | 475 | 42% |
| 1520 | 1550 | 1580 | 18 | 10 | 50 | 3 | 150 | 7% |

Common CD-burning lasers have a wavelength of about 780 nm and can be adapted for use as a radiation sources in conjunction with the embodiments disclosed herein. Examples of radiation absorbers that are suitable for use in the infrared range can include, but are not limited to, polymethyl indoliums, metal complex IR dyes, indocyanine green, polymethine dyes such as pyrimidinetrione-cyclopentylidenes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexafunctional polyester oligomers, heterocyclic compounds, and combinations thereof. Several specific polymethyl indolium compounds are available from Aldrich Chemical Company and include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-11-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene-]-2-(phenylthio)-1-cyclohexen-1-yl]ethenyl]-3,3-dimethyl-1-propylindolium perchlorate; and mixtures thereof. Alternatively, the radiation absorber can be an inorganic compound, e.g., ferric oxide, carbon black, selenium, or the like. Polymethine dyes or derivatives thereof such as a pyrimidinetrione-cyclopentylidene, squarylium dyes such as guaiazulenyl dyes, croconium dyes, or mixtures thereof can also be used. Suitable infrared sensitive pyrimidinetrione-cyclopentylidene radiation absorbers include, for example, 2,4,6(1H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9CI) (S0322 available from Few Chemicals, Germany).

In other embodiments, a radiation absorber can be included that preferentially absorbs wavelengths in the range from about 600 nm to about 720 nm, and more specifically at about 650 nm. Non-limiting examples of suitable radiation absorbers for use in this range of wavelengths include indocyanine dyes such as 3H-indolium, 2-[5-(1,3-dihydro-3,3-dimethyl-1-propyl-2H-indol-2-ylidene)-1,3-pentadienyl]-3,3-dimethyl-1-propyl-iodide), 3H-indolium, 1-butyl-2-[5-(1-butyl-1,3-dihydro-3,3-dimethyl-2H-indol-2-ylidene)-1,3-pentadienyl]-3,3-dimethyl-perchlorate, and phenoxazine derivatives such as phenoxazin-5-ium, 3,7-bis(diethylamino)perchlorate. Phthalocyanine dyes such as silicon 2,3-napthalocyanine bis(trihexylsilyloxide) and matrix soluble derivatives of 2,3-napthalocyanine (both commercially available from Aldrich Chemical), matrix soluble derivatives of silicon phthalocyanine (as described in Rodgers, A. J. et al., 107 J. Phys. Chem. A 3503-3514, May 8, 2003), matrix soluble derivatives of benzophthalocyanines (as described in Aoudia, Mohamed, 119 J. Am. Chem. Soc. 6029-6039, Jul. 2, 1997), phthalocyanine compounds such as those described in

U.S. Pat. Nos. 6,015,896 and 6,025,486 (which are each incorporated herein by reference), and Cirrus 715, a phthalocyanine dye available from Avecia, Manchester, England, may also be used.

In still other embodiments, the embodiments disclosed herein may be used with a radiation source such as a laser or LED that emits light having blue and indigo wavelengths ranging from about 380 nm to about 420 nm. In particular, radiation sources such as the lasers used in certain DVD and laser disk recording equipment emit energy at a wavelength of about 405 nm. Radiation absorbers that most efficiently absorb radiation in these wavelengths may include, but are not limited to, aluminum quinoline complexes, porphyrins, porphins, and mixtures or derivatives thereof. Some specific examples of radiation absorbers suitable for use with radiation sources that output radiation between 380 nm and 420 nm include 1-(2-chloro-5-sulfophenyl)-3-methyl-4-(4-sulfophenyl)azo-2-pyrazolin-5-one disodium salt; ethyl 7-diethylaminocoumarin-3-carboxylate; 3,3′-diethylthiacyanine ethylsulfate; 3-allyl-5-(3-ethyl-4-methyl-2-thiazolinylidene) rhodanine (each available from Organica Feinchemie GmbH Wolfen), and mixtures thereof. Other examples of suitable radiation absorbers include, but are not limited to aluminum quinoline complexes such as tris(8-hydroxyquinolinato) aluminum (CAS 2085-33-8) and derivatives such as tris(5-cholor-8-hydroxyquinolinato) aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 244,5-dihydronaphtho[1,2-d]-1,3-dithiol-2-ylidene)-4,5-dihydro-naphtho[1-,2-d]1,3-dithiole, all available from Syntec GmbH. Other non-limiting examples of specific porphyrin and porphyrin derivatives include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Methyl Yellow (60-11-7), 4-phenylazoaniline (CAS 60-09-3), Alcian Yellow (CAS 61968-76-1) available from Aldrich chemical company, and mixtures thereof.

For blue laser writing, absorbers are sometimes used that absorb radiation and transfer the energy to the color forming composition at specific wavelengths of light. For the purposes of this application, wavelengths at 405 nm, 605 nm and 780 nm are desirable. It is believed that the absorber that absorbs at 405 nm is the most difficult to obtain. Not many absorbers are known that readily absorb light having a λmax at 405 nm. One of the few includes porphyrins which tend to be difficult or expensive to obtain. It is also known that some polymethylene dyes can absorb radiation at 405 nm. Besides their ability to absorb, these absorber dyes should also be soluble in the media being used on the disc. They should also be compatible with leuco dyes.

It is known that polymethine dyes can work as radiation absorbers at 405 nm. However, screens performed with polymethine dyes showed slower color development than needed for effective media recording at 405 nm. This was due, at least in part, to factors related to either slower diffusion or inadequate initial distribution. This was not directly related to the polymethine dye absorber by itself but rather to compatibility problems between the developer and the absorber.

Curcumin A and Curcumin B, two derivatives of turmeric spice, are effective radiation absorbers at 405 nm under conditions suitable for optically recording data on a Blue laser disc. Besides finding that Curcumin A and B are effective radiation absorbers at 405 nm, the applicants also found that the reaction which occurs with the Curcumin A and B when they are radiated at 405 nm also produces phenol, which enhances the color forming step of the leuco dye.

### Matrix Materials

In some embodiments, matrix materials are used. The matrix material can be any composition suitable for dissolving and/or dispersing the developer, and color-former (or color-former/melting aid alloy). Acceptable matrix materials include, by way of example, UV-curable matrices such as acrylate derivatives, oligomers and monomers, with or without a photo package. A photo package may include a light-absorbing species which initiates reactions for curing of a matrix, such as, by way of example, benzophenone derivatives. Other examples of photoinitiators for free radical polymerization monomers and pre-polymers include, but are not limited to, thioxanethone derivatives, anthraquinone derivatives, acetophenones and benzoine ether types. It may be desirable to choose a matrix that can be cured by a form of radiation other than the type of radiation that causes a color change.

Matrices based on cationic polymerization resins may require photo-initiators based on aromatic diazonium salts, aromatic halonium salts, aromatic sulfonium salts and metallocene compounds. An example of an acceptable matrix or matrices includes Nor-Cote CLCDG-1250A or Nor-Cote CDG000 (mixtures of UV curable acrylate monomers and oligomers), which contains a photoinitiator (hydroxy ketone) and organic solvent acrylates (e.g., methyl methacrylate, hexyl methacrylate, beta-phenoxy ethyl acrylate, and hexamethylene acrylate). Other acceptable matrixes or matrices include acrylated polyester oligomers such as CN292, CN293, CN294, SR351 (trimethylolpropane tri acrylate), SR395 (isodecyl acrylate), and SR256 (2(2-ethoxyethoxy) ethyl acrylate) available from Sartomer Co.

The imaging compositions formed in the manner described herein can be applied to the surface of an imaging medium 100, such as a CD, DVD, HD-DVD, BLU-RAY disc or the like. Further, discs may be used in systems disclosed herein that include optical recording and/or reading capabilities. Such systems typically include a laser emitting light (e.g., light source 150) having a predetermined wavelength and power. Systems that include optical reading capability further include an optical pickup unit 157 coupled to the laser. Lasers and optical pickup units are known in the art.

Referring again to FIGS. 1 and 2, an exemplary read/write system 170 includes the processor 166, the laser 150, and the optical pickup 157. Signals 163 from processor 166 cause laser 150 to emit light at the desired power level. Light reflected from the disc surface is detected by pickup 157, which in turn sends a corresponding signal 165 back to processor 166.

When it is desired to record, the imaging medium 100 is positioned such that light emitted by laser 150 is incident on the marking surface 230. The laser 150 is operated such that the light incident on the marking layer 230 transfers sufficient energy to the surface to cause a mark, such as 242. Both the laser 150 and the position of the imaging medium 100 are controlled by the processor 166, such that light is emitted by the laser 150 in pulses that form a pattern of marks 242 on the surface of the imaging medium 100.

When it is desired to read a pattern of marks 242 on the surface of an imaging medium 100, the imaging medium 100 is again positioned such that light emitted by laser 150 is incident on the marked surface. The laser 150 is operated such that the light incident at the surface does not transfer sufficient energy to the surface to cause a mark. Instead, the incident light is reflected from the marked surface to a greater or lesser degree, depending on the absence or presence of a mark 242. As the imaging medium 100 moves, changes in reflectance are recorded by optical pickup 157 which generates a signal 165 corresponding to the marked surface. Both the laser 150 and the position of the imaging medium 100 are controlled by the processor 166 during the reading process.

It will be understood that the read/write system 170 described herein is merely exemplary and includes components that are understood in the art. Various modifications can be made, including the use of multiple lasers, processors, and/or pickups and the use of light having different wavelengths. The read components may be separated from the write components, or may be combined in a single device. In some embodiments, imaging media 100 may be used with optical read/write equiμment operating at wavelengths ranging between 380 nm and 420 nm.

While several embodiments have been described in detail, it will be apparent to those skilled in the art that the disclosed embodiments may be modified. Therefore, the foregoing description is to be considered exemplary rather than limiting.

What is claimed is:

1. An apparatus for at least one of recording or transmitting optical data or visual images, comprising:
an optical data or visual image recording medium (100) including a substrate (220) and a markable coating (230) on the substrate (220); and
a recording and transmitting device including a light source (150) having at least two separate lasers, and a unified apochromatic lens structure (148) having at least two separate lenses functioning as one structure; the lens structure (148) enabling light beams (152) from the light source (150) to at least one of a) pass through the lens structure (148) onto the medium (100) with at least two different wavelengths directed to a single spot on the medium (100), so as to cause a localized change in at least one of chemical or physical properties to form an optically detectable mark (242) in the markable coating (230), or b) pass through the lens structure (148) onto the medium (100) with at least two different wavelengths directed to a single spot on the medium (100) so as to cause an optically detectable mark (242) to reflect the light beams (152), the light beams (152) having radiation different from a wavelength suitable for forming the optically detectable mark (242) in the markable coating (230).

2. The apparatus of claim 1 wherein for optically transmitting data or visual images, the apparatus further comprises:
a sensor (157) positioned so as to detect at least one readable pattern of the optically detectable mark (242) on the optical recording medium (100), the sensor (157) reading the at least one readable pattern as the optical recording medium (100) moves in relation to the sensor (157); and
a processor (166) to which the sensor (157) sends at least one signal based on the at least one readable pattern detected by the sensor (157) from the optical recording medium (100).

3. The apparatus of claim 1 wherein the lens structure (148) includes at least three separate lenses functioning as one structure.

4. The apparatus of claim 1 wherein the at least two different wavelengths include three wavelengths: 405 nm, 650 nm, and 780 nm, each wavelength focused together and centered to a single spot, the single spot having a diameter ranging from about 100 nanometers to about 10 microns.

5. The apparatus of claim 1 wherein the at least two separate lenses are a) adhered together by a chemical adherent; b) manufactured together as one piece; or c) positioned adjacent to each other as at least two separate lens pieces.

6. A unified apochromatic lens structure (148) for at least one of recording or transmitting optical data or visual images, comprising:
at least two separate lenses functioning as one structure through which at
least one light beam (152) having at least two different wavelengths can focus on an optical recording medium (100), the at least one light beam (152) being from a light source (150) having at least two separate lasers;
wherein the at least two different wavelengths of the at least one light beam (152) are focused together on a single spot on the optical recording medium (100).

7. The lens structure (148) of claim 6 wherein the at least one light beam (152) includes three wavelengths: 405 nm, 650 nm, and 780 nm, the wavelengths focused together to a single spot, the single spot having a diameter ranging from about 100 nanometers to about 10 microns.

8. The lens structure (148) of claim 6 wherein the at least two separate lenses are a) adhered together by a chemical adherent; b) manufactured together as one piece; or c) positioned adjacent to each other as at least two separate lens pieces.

9. A method for at least one of i) reading optically recorded data or visual images, or ii) optically recording data or visual images, the method comprising:
providing a light source (150) including at least two separate lenses;
providing an optical recording medium (100) including a substrate (220) coated with a markable coating (230);
providing a unified apochromatic lens structure (148) including at least two separate lenses to focus at least two different wavelengths beamed from the light source (150) onto the medium (100); and
beaming light (152) from the light source (150) through the unified apochromatic lens structure (148), the lens structure (148) enabling the light (152) to pass through the lens structure (148) so that the at least two different wavelengths are centered at a single spot on the medium (100) so as to i) cause a localized change in at least one of chemical or physical properties to form a single optically detectable mark (242) in the markable coating (230) or ii) cause at least one optically detectable mark (242) on the single spot to reflect the light (152), the light (152) having radiation different from a wavelength suitable for forming the at least one optically detectable mark (242) in the markable coating (230).

10. The method of claim 9 wherein the lens structure (148) includes at least three separate lenses functioning as one structure.

11. The method of claim 9 wherein the at least two different wavelengths include three wavelengths: 405 nm, 650 nm, and 780 nm, the wavelengths focused together to a single spot, the single spot having a diameter ranging from about 100 nanometers to about 10 microns.

12. The method of claim 9 wherein the at least two separate lenses are a) adhered together by a chemical adherent; b) manufactured together as one piece; or c) positioned adjacent to each other as at least two separate lens pieces.

13. The method of claim 9 wherein the at least one optically detectable mark (242) reflects light, and wherein the method further comprises:
detecting by a sensor (157) at least one readable pattern of the at least one optically detectable mark (242) illuminated by the radiated light (152) on the optical recording medium (100), the sensor (157) reading the at least one readable pattern as the optical recording medium (100) moves in relation to the sensor (157); and
sending from the sensor (157) to a processor (166) at least one signal based on the at least one readable pattern detected by the sensor (157).

14. An optical data or visual image recording system (170), comprising:
an optical recording medium (100) including a substrate (220) and a markable coating (230) on the substrate (220); and
a light source (150) including at least two separate lasers, the light source (150) being associated with a unified apochromatic lens structure (148) including at least two separate lenses, the lens structure (148) enabling the light source (150) to focus together onto the medium (100) at least two different wavelengths to a single spot on the medium (100) so as to cause a localized change in at least one of chemical or physical properties to form a single optically detectable mark (242) in the markable coating (230).

15. The recording system (170) of claim 14 wherein the lens structure (148) includes at least three separate lenses functioning as one structure.

16. The recording system (170) of claim 14 wherein the at least two different wavelengths include three wavelengths: 405 nm, 650 nm, and 780 nm, the wavelengths focused together to a single spot, the single spot having a diameter ranging from about 100 nanometers to about 10 microns.

17. The recording system (170) of claim 14 wherein the at least two separate lenses are a) adhered together by a chemical adherent; b) manufactured together as one piece; or c) positioned adjacent to each other as at least two separate lens pieces.

18. An optical transmitting system (170), comprising:
an optical recording medium (100) including a substrate (220) and a markable coating (230) on the substrate (220), the optical recording medium (100) previously having had optically detectable marks (242) formed in the markable coating (230);
a light source (150) including at least two separate lasers, the light source (150) being associated with a unified apochromatic lens structure (148) including at least two separate lenses, the lens structure (148) enabling the light source (150) to focus at least two different wavelengths to a single spot on the medium (100) so as to cause at least one optically detectable mark (242) to reflect light (152) from the light source (150), the light (152) having radiation different from a wavelength suitable for forming the at least one optically detectable mark (242) in the markable coating (230);
a sensor (157) positioned so as to detect at least one readable pattern of the at least one optically detectable mark (242) illuminated by the light (152), the sensor (157) reading the at least one readable pattern as the optical recording medium (100) moves in relation to the sensor (157);
a processor (166) to which the sensor (157) sends at least one signal based on the at least one readable pattern detected by the sensor (157);
an analyzer (168) to which the processor (166) sends the at least one signal to analyze so that the at least one signal can be collected and stored as data; and
a computer data base (114) to which the analyzer (168) sends the data from the at least one signal for collecting and storing and from which the data can be accessed.

19. The optical transmitting system (170) of claim 18 wherein the lens structure (148) includes at least three separate lenses positioned together to form one structure.

20. The optical transmitting system (170) of claim 18 wherein the at least two different wavelengths include three wavelengths: 405 nm, 650 nm, and 780 nm, each wavelength focused together to the same spot having a diameter ranging from about 100 nanometers to about 10 microns.

21. The optical transmitting system (170) of claim 18 wherein the at least two separate lenses are a) adhered together by a chemical adherent; b) manufactured together as one piece; or c) positioned adjacent to each other as at least two separate lens pieces.
